(19) United States
(12) Patent Application Publication
(10) Pub. No.: US 2019/0377669 A1
(43) Pub. Date: Dec. 12, 2019

(54) FRAMEWORK FOR VISUAL AUDIT EMULATION FOR APPLICATION

(71) Applicant: UST Global (Singapore) Pte. Ltd., Singapore (SG)

(72) Inventors: Aby Jacob, Trivandrum (IN); Satheesh Gopalakrishna Pillai, Trivandrum (IN)

(21) Appl. No.: 16/434,625

(22) Filed: Jun. 7, 2019

(30) Foreign Application Priority Data
Jun. 7, 2018 (IN) 201811021382

(51) Int. Cl. G06F 11/36; G06F 11/34

(52) U.S. Cl. CPC G06F 11/3688; G06F 11/3438; G06F 11/3692

(57) ABSTRACT

A system and method to generate an audit trail based on operation of a target application. The system includes a computing device operable to execute the target application. The target software generates user interfaces audit data in response to user inputs. The audit data generated by the target application is stored. An audit visualization framework reads the audit database and creates a video playback file of user actions that occur as the user interacts with the audited target application.

### PRIORITY CLAIM

This application claims priority to Indian Provisional Application No. 201811021382, filed Jun. 7, 2018. That application in its entirety is hereby incorporated by reference.

### TECHNICAL FIELD

The present disclosure relates generally to an audit system, and more specifically, to a method and system to allow a visual audit of the operation of a computing application by a user.

### BACKGROUND

There is an increasing-need to be able to track changes to information stored in computerized information networks that can be accessed by multiple users. Often, government regulations require certain information to be tracked to protect consumers. For example, banks and other financial institutions are required to track changes to accounts to protect customers and prevent fraud. Other requirements, aside from government regulations, also exist for providing the ability to ‘track’ changes with respect to the information. For example, companies worldwide require the facility to track customer-service requests, including the arrival date, the status of the request, the service representative handling the request, and the resolution date of the request.

The organizations typically have one or more enterprise application programs installed on servers administered by the organization. Audit trails can be utilized in many other types of enterprise application programs to comply with government-regulations, track performance, maintain database security, and document modifications for future analysis and record keeping. Audit trails are a security-relevant chronological-record, set of records, and/or destination and source of records that provide documentary evidence of the sequence of activities that have affected at any time a specific operation, procedure, or event. Such activities are often the operation of computer applications by different users who may be responsible for changing the stored information via the operation of the computer applications.

Yet, conventional audit-trail systems are limited to present information in text format in the form of a timeline. Accordingly, to reconstruct a chain of events as would have happened, a user is compelled to rely on his visualization. There are no existing solutions/products that reconstruct and display a user's interaction with any machine or interface (e.g. a GUI of a software application) to create an audit trail.

Overall, the conventional audit-trail based tools end up providing an audit trail as text which corresponds to a timeline. A visual representation of the user's activities in the application is not provided by these solutions. There are presently no means to create a visual representation and emulation of the exact activities performed by the user when operating software applications.

Accordingly, the conventional audit-trail based tools substantially fall short of presenting the audit-trail data in a format that is readily understandable and accordingly requires huge rounds of brainstorming by the end-users to derive meaningful and accurate interpretation. A screen video recording could be taken of a user's interaction with a software application on a computer, but storage of such video files would consume a significant amount of storage space and would not expose all of the activities performed by the user through mere screen capture.

Thus, there lies at least a need for a system that allows the visual-display of an audit trail for a user's interaction with software or other embedded systems. There is also a need for a system that can generate an audit video file that is sufficiently small in size to allow more such files to be stored. There is also a need for an audit system that is compatible with various operating systems and programming languages.

### SUMMARY

One disclosed example is a system to generate an audit trail based on operation of a target application. The system includes a computing device operable to execute the target application. The computing device includes an input device and a display. The target application generates a plurality of user interfaces on the display and audit data in response to user inputs received from the input device. The system includes a memory coupled to the computing device to store the audit data generated by the target application. An auditing device is coupled to the memory and the computing device. The auditing device is operable to generate a video file of the operation of the target application based on one of a plurality of templates, each of the templates corresponding to one of the user interfaces, and the audit data generated from a user input received from the input device, the user input associated with one of the user interfaces.

Another disclosed example is a method of providing a visual audit trail of operating a target application. The target application is executed from a computing device. The target application generates audit data associated with the actions of a user operating the target application. The audit data is stored in a database on a storage device. A template associated with a user interface generated by the target application is accessed. An audit video file is generated from the template and the audit data, the audit video is indicative of the actions of the user operating the target application.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1 is a block diagram of an example video audit trail system;

FIG. 2 is an example table with target application actions and corresponding timestamps;

FIG. 3 is a flow diagram showing the process of gathering audit data for an example log in process for a target application;

FIG. 4 is a flow diagram showing the process of the target application in the example log in process;

FIG. 5 is the flow diagram for the example log in process that is used by the system 100 to combine audit data and templates to create the appropriate visual audit log;

FIGS. 6A-6F is a series of screen shots showing the video playback generated by the system 100 in FIG. 1 for an example interaction with the target audited application;

FIGS. 7A-7C are another series of screen images showing the generation of video playback by the system 100 in FIG. 1 for an example interaction with another target audited application;

FIG. 8A is a table of audit data used to generate the video playback using the images in FIGS. 7A-7C;

FIG. 8B is a table of payload data referenced by the audit data table in FIG. 8A;

FIGS. 9A-9C are another series of screen images showing the generation of video playback by the system 100 in FIG. 1 for an example interaction with another target audited application;

FIG. 10A is a table of audit data used to generate the video playback using the images in FIGS. 9A-9C;

FIG. 10B is a table of payload data referenced by the audit data table in FIG. 10A; and

FIGS. 11-12 are block diagrams of example computing devices that may be used for the audit trail system.

The present disclosure is susceptible to various modifications and alternative forms. Some representative embodiments are shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

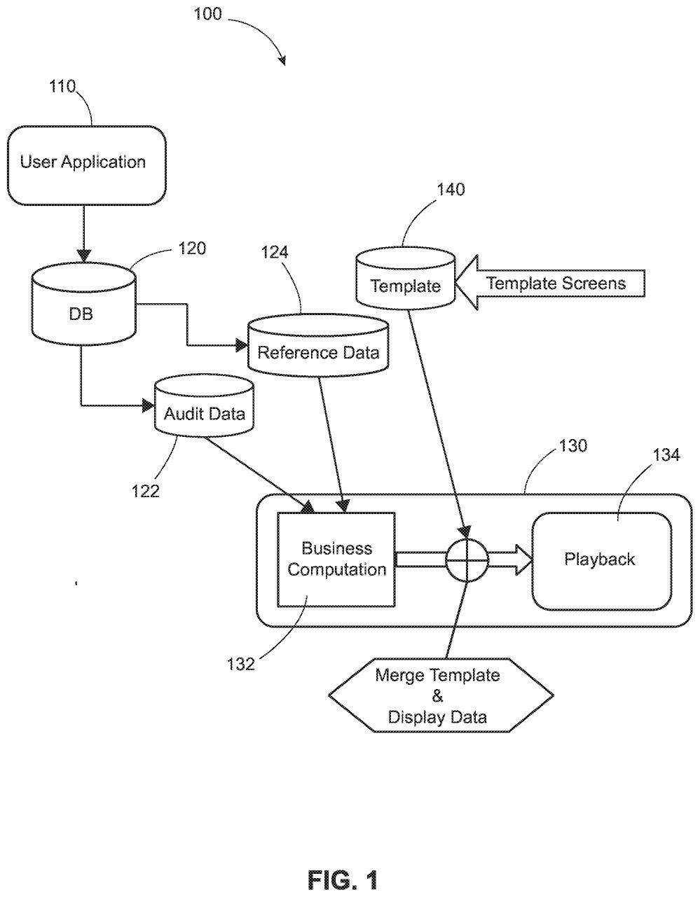

FIG. 1 shows an example video audit trail system 100. The system 100 allows the auditing of a target audit application 110 embodied as a software application. The target application 110 is executed by a computing device such as a workstation, a personal computer or the like. The computing device includes an input device such as a keyboard or a mouse. The computing device also includes an electronic display, such as a video display. The target application 110 generates graphical user interfaces that are displayed on the display in response to a user providing inputs on the input devices. The target application 110 also generates audit data of the user operating the target application 110. The audit data may be stored on the computing device or in other storage devices coupled to the computing device via a network, such as an Intranet or the Internet.

In this example, the inputs from the user application 110 using one or more human-machine input devices (e.g., mouse click, touchscreen gesture, keyboard input) in the form of the audit data are stored in an electronic database 120. The database 120 may be directly connected to the computing device or may be coupled via a network. The data in the database 120 is split into audit data 122 and reference data 124. An audit server 130 is coupled to the database 120 via the network. The audit server 130 includes a business computation module 132 and a playback module 134. The playback module 134 accesses a series of template screens 140 and merges them with display data from the audit data 122 and reference data 124. Each of the template screens 140 corresponds with one of the electronic user interfaces or electronic pages generated by the target application 110, and includes displayed content on those interfaces or pages as seen by the user on the electronic display.

The system 100 operates on data available from the audit trail of another software application such as the target application 110 in FIG. 1. The context information and the background pages from the audited application are entered into the system 100. The system 100 reconstructs the user's actions with the target application by using the data elements fed into the target application 110. These elements include user actions and a time stamp of those actions.

The system 100 can be integrated with any target software application that has audit trail capabilities and a GUI for human/machine interaction. As will be explained below the audit information is displayed via the playback module 134 in a video form for review by an operator.

Depending on the use case and conditional requirements, the system 100 may fetch data directly from the target application 110 if that information is required for reconstruction of a given page or screen presented to the user. At any given time, the system 100 treats the corresponding page/screen presented by the target application 110 as having static and dynamic components. An example of a static component may be static images including text of the pages/screens captured from the audited application 110 to be displayed in the system 100. An example of a dynamic component may be audit trail data from the audited application 110 (e.g., a user enters text using a keyboard into the target application 110 or drags an item on the screen to invoke an action by the target application or any other human-machine interaction that occurs over a time range). The dynamic content is overlaid on the static image frame/page to recreate the original user action at a given time.

The system 100 may use any standard mode of data extraction from the target application, e.g.: JDBC/ODBC/Web services/APIs, etc. In case a direct fit is not applicable or feasible with the database of the target application, then the system 100 may use simple extraction, transformation and loading (“ETL”) of data from the target application to ensure interoperability.

In order to create the playback video, the system 100 uses audit data 122, relevant target application reference data 124 from an associated database, and templates 140. The audit data is created by user action in the originating system or application such as the application 110 in FIG. 1. The system 100 requires audit data from the audited target application 110. Most applications contain audit data of user interaction with the audited target application 110. The audited target application 110 will have audit data stored or some other form of storage to track user actions. The more exhaustive the data provided by the target application, the more accurate the generated video playback from the playback module 134 will be.

The dynamic data at any given point in time ‘t’ for a user needs to be available in the database 120 of the target audit application 110 for ease of reconstruction. It would also be acceptable if the minimum required information is available within the audit data itself. The technique of reconstruction by the system 100 is agnostic to all operating systems and computer programming languages.

The other relevant target application reference data 124 from a database may be used to present data to the user at the time of his/her session in the audited application. The reference data could include data from the audited application's database or data from the audited application's backup database. The page/screen templates such as the templates 140 in FIG. 1, are templates that resemble the screens/pages in the audited target application 110, without user-specific data in the display.

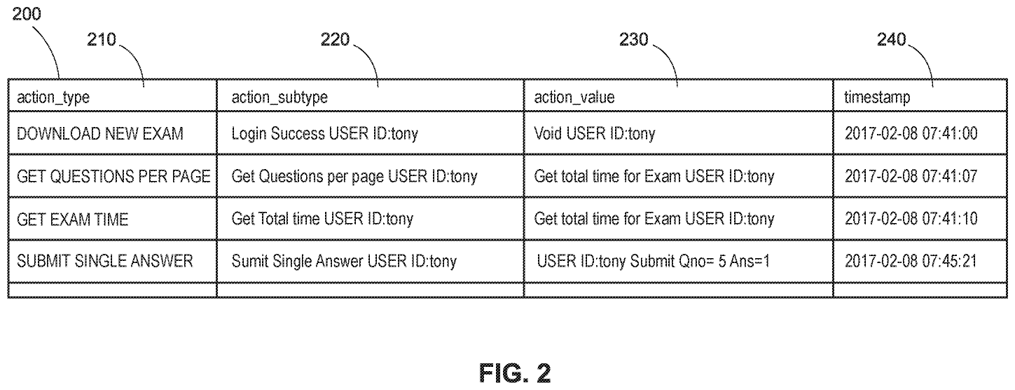

The dynamic component includes a timestamp to provide the time the component was captured. For example, timestamped data may be captured from the audited application. Timestamped data allows for the construction of a sequential emulation of user activities within the audited application. FIG. 2 shows an example table 200 that shows categories of actions and subactions, created values, and timestamps that are used in the dynamic components generated from a target application such as the target application 110 in FIG. 1. The table 200 includes an action type column 210, an action subtype column 220, an action value column 230, and a timestamp column 240. The action type column 210 includes a listing of different actions that occur in the operation of the target application. The action subtype column 220 includes specific subactions related to the corresponding actions in column 210. For example, for an action “DOWNLOAD EXAM”, there is a corresponding sub-action “User-Login” requiring the user to authenticate itself prior to download the examination question paper. The action value column 220 references the data values (e.g. User ID/password values as inputted by user) that will be inserted or overlaid in the template for the purposes of generating the playback video, in response to the action and sub-action. The timestamp column 240 includes the corresponding timestamp data associated with each action and subaction.

The system 100 allows understanding of cause and effect within the audited target application 110. The system 100 unites metadata for each page/screen of the target application 110 to user actions described in the timestamp record, thus allowing for overlay of user-specific entries or actions onto the static screens/pages stored by the system 100 for the audited application 110.

The system's methodology is tailored to emulate the outcomes (cause/effect) in the target application. In one example, the simplest form of algorithm used for emulating the flow in a vast majority of target application is a “decision tree algorithm.” A decision tree is a flowchart-like structure in which each internal node represents an “action” on an attribute (e.g., whether a coin flip comes up heads or tails, in this case it is a user action), each branch represents the outcome of the user action, and each leaf node represents a class label (i.e., decision taken after computing all attributes, in this case the outcome is an integrated template with static and dynamic data). The paths from root to leaf represent classification rules.

If necessary, as a part of alternative embodiments (e.g. in exceptional scenarios), the system 100 can also make use of process (e.g. algorithm) within the target application 110 to compute the final-value that was viewed by the user at a point in time. Such reusability can be achieved by calling application programming interfaces (API)s available with the target application or web services such as integration layers that are provided by the target application.

The system 100 also allows the emulation of interactions of a user with the audited application 110. The system 100 generates pages/screens from the sequential audit trails available from the audited application 110 and displays one after another, resulting in a video playback that displays every relevant action of the user within the audited application 110. In this example, the size of the video playback file is approximately 1/10th the size of other commonly used video recording files.

A mouse pointer may be displayed in the emulation playback. For display of the mouse pointer the system 100 must be set do so based upon data compiled from the timestamp list of actions to determine sequences and thus placement of mouse pointer on the applicable page/screen for the audited application 110. There may be different procedures to display the mouse pointer. For example, if the action was a click of “login” then the mouse pointer can be rendered over the login button on the constructed screen. Another alternative is using mouse coordinates to render the mouse pointer. As will be explained below, the mouse coordinates of the system 110 can be captured using AJAX or equivalent technologies whereby the audit data will have higher fidelity and hence system 100 can easily identify the mouse interaction of a user as well and render it in every output screen.

The process flow for producing audit visualization is as follows. The audit visualization framework dissects each graphical user interface (GUI) frame in the target application into static and dynamic elements. The static elements of an application's GUI are those which remain the same irrespective of the user, time of login, state of user or application information, etc. Those components, information, data which are variable are considered as dynamic elements.

The audit visualization framework uses information available in the database to recreate the dynamic elements by re-using existing functions within the application or bespoke functions. A decision tree algorithm in line with the application flow is used to identify and render the relevant static element (template), and overlay the dynamic content to regenerate/recreate the state/appearance of the GUI and user interaction at any given instant of time in the past.

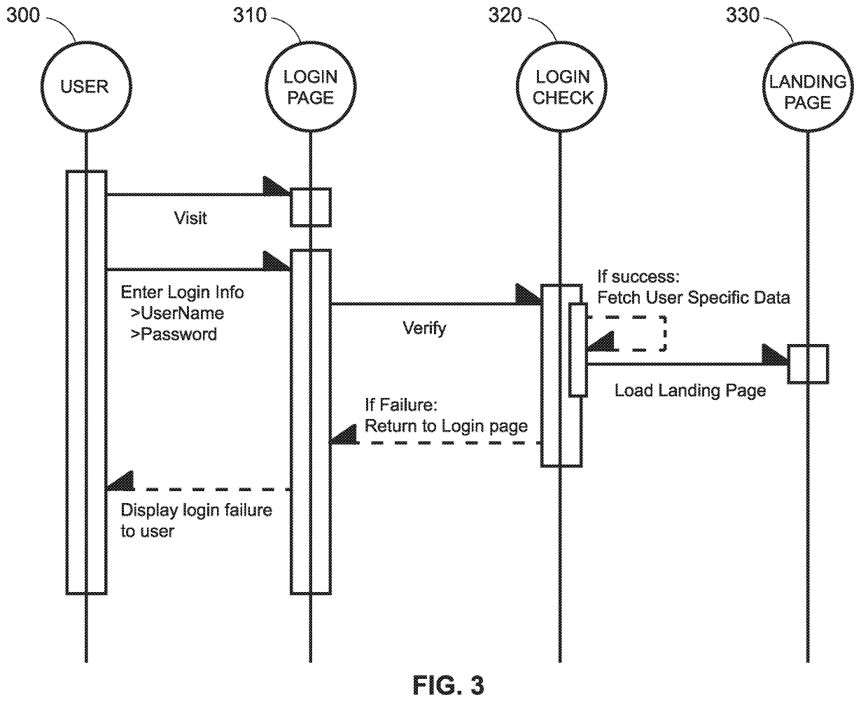

FIG. 3 is a flow diagram showing the process of gathering visual audit data for an example log in process for a target application. FIG. 3 is an example how the login activity of a user on the audited application 110 is regenerated by the system 100. The system 100 operates on an interactive flow between the audited application and the system 100. For the target audited application such as the application 110 in FIG. 1, a user requests a login URL (this is the same for all users) (300). The system 100 uses the login template as entry point for every user activity (310). For the target audited application, the next step is the user keys in a username and a password and clicks login. The data log of the system 100 monitors the log in attempt by capturing the audit data in the database 120. The validation outcome is also captured. The system 100 uses the login template and data from the database on the login attempt by the user to render the user name and password masked as (********) on top of the login template.

In the next step, the target audited application 110 validates the keyed-in credentials and reactive action occurs (320). The data logging of the system 100 then inserts the outcome of the credential check into audit logs in the database. The outcome may be a success or a failure with a specific reason. The outcome of the credential check is available in the database and hence the corresponding decision tree algorithm routes the action to the relevant branch. In this example, the decision tree would have a successful login path and an unsuccessful login path.

If the user is successful, the system 100 follows the successful login path to load a landing page (330). The system 100 will know that the landing page of the target application 110 will be displayed to the user and in the process, it will call the function within the target application 110 or a bespoke function to load the user specific data. The system 100 then will overlay user-specific data on a landing page template. The system 100 thus recreates the exact user interface that the user had seen at the instant of the login. Every recreated user interface screen is accompanied with an embedded timestamp of the user action, which provides more detail about the action sequence.

In the case, the user is unsuccessful in login, the system 100 follows the login unsuccessful path of the decision tree. Thus, if the credential check failed, then the system 100 knows that the login page of the application 110 with an error message is to be displayed to the user. Hence the system 110 will use the login template and overlay an error message to recreate the user interface.

After the system 100 has reconstructed the templates that the user had seen during the activity on the target application 110, the system 100 stitches the frames together to form a video using the embedded time stamp of the user activity to create a correct linear flow. If, for example, the user had spent 15 seconds for the login activity the output video of the same activity might be 3 seconds, thus effectively compressing the time duration of the video sequence of the user's actions.

If the exact time frame of user activity is to be emulated in the video then the system 100 knows the time stamps of each reconstructed frame. This information is used to playback the frames throughout the time difference between the activities. The higher the granularity and frequency of the audit, the higher the fidelity of the output audit file. If mouse pointer movement by the user is also needed in the video then the mouse pointer coordinates must be captured in the database or other file system or sources from which the mouse pointer can be treated as a dynamic element on the template.

Technically, the mouse coordinates can be captured as (X, Y) coordinates and passed to the backend of the system 100 using Ajax requests or equivalent technologies. It is also possible to overlay the data onto user interface wireframes and emulate the user flow and activity. The mode of output can be changed depending on need.

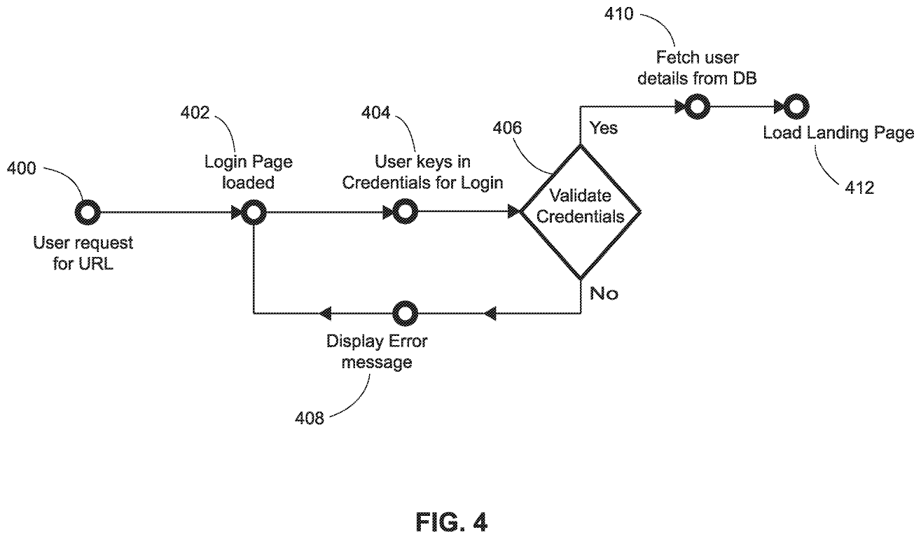

FIG. 4 is a flow diagram showing the process of the example target application in the example log in process. A user request for the application URL is received (400). The login page is loaded (402). The user keys in the proper credential such as a user name and password on the login page (404). The target application then validates the credentials (406). If the credentials are not validated, an error message is displayed (408), and the log in page is reloaded (402).

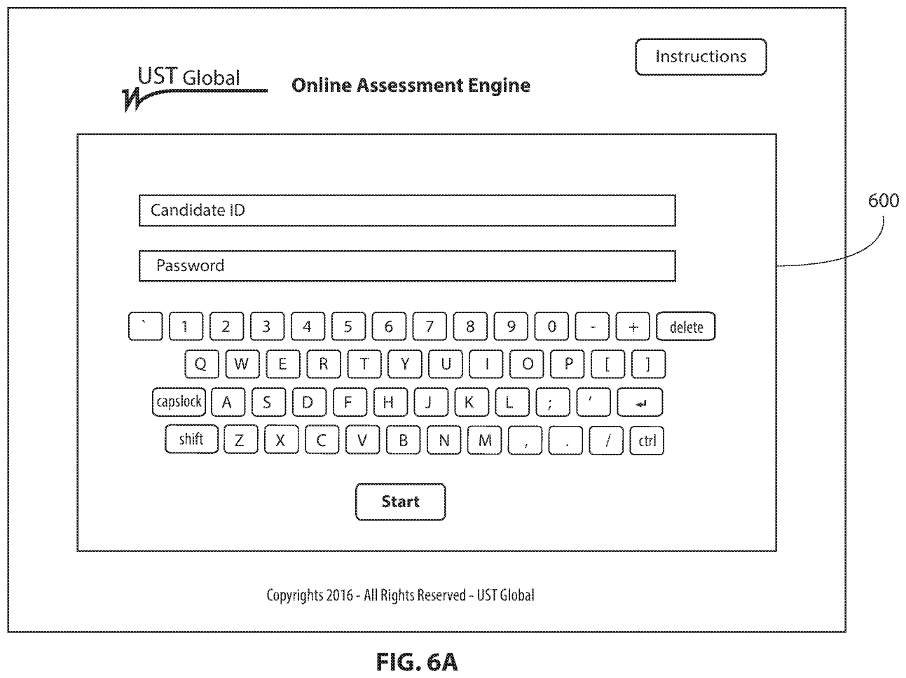

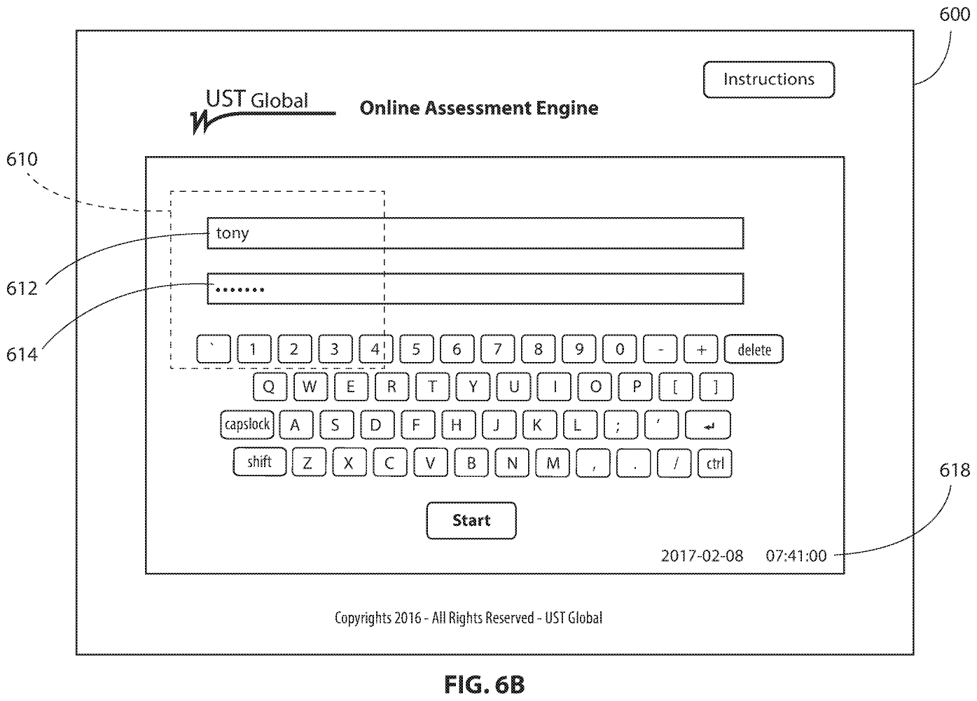

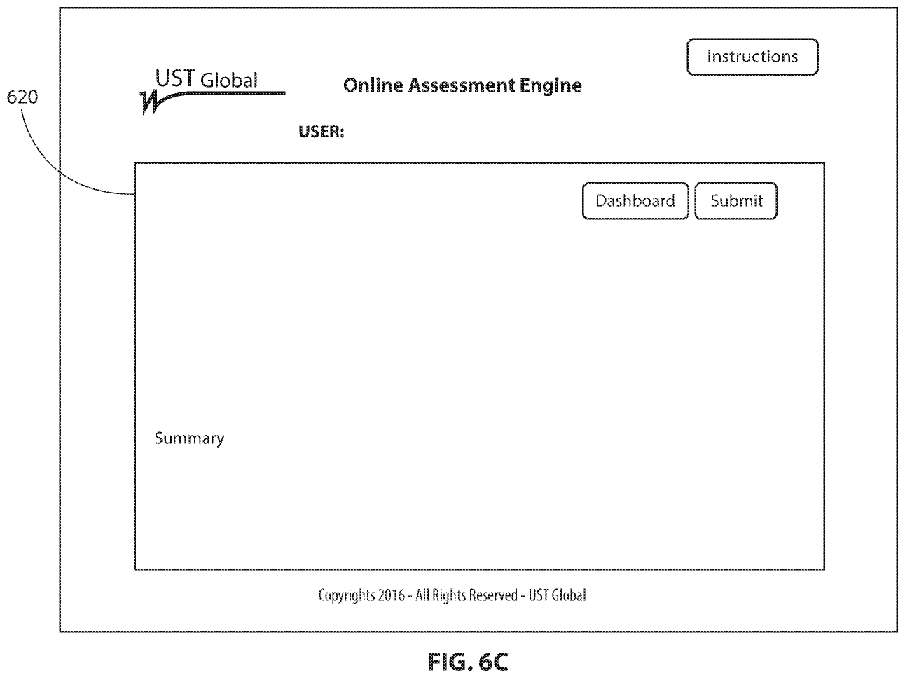

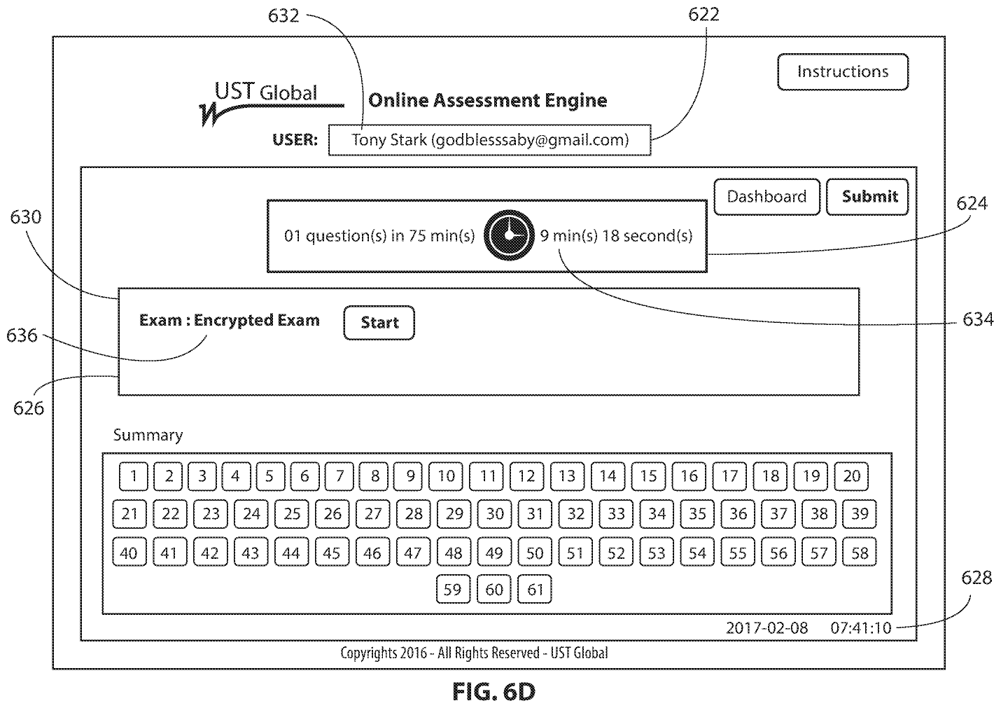

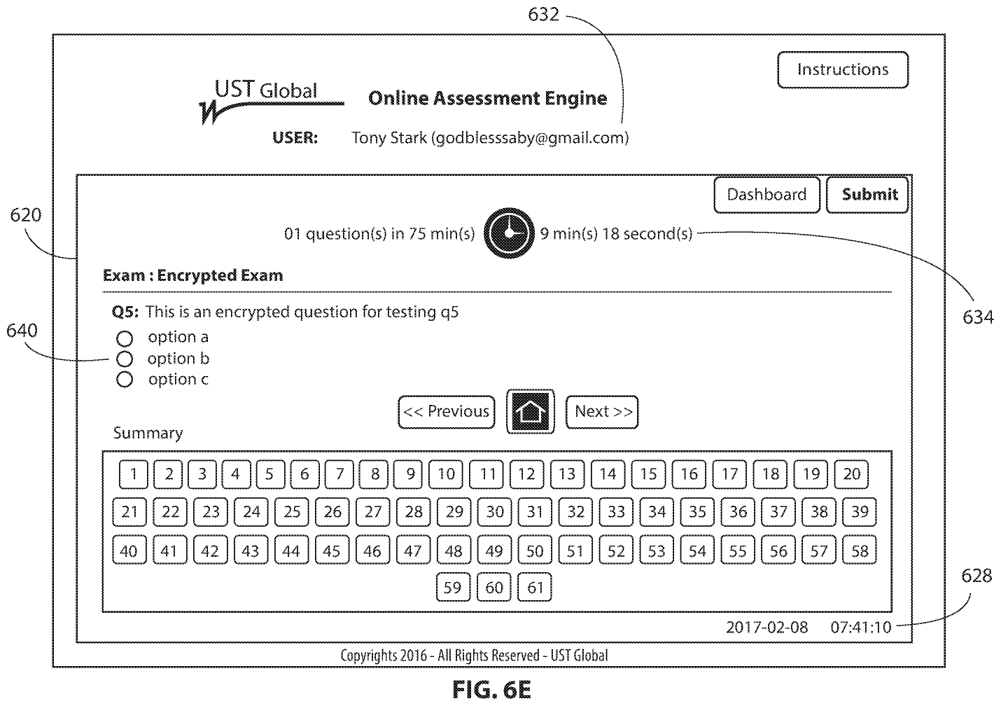

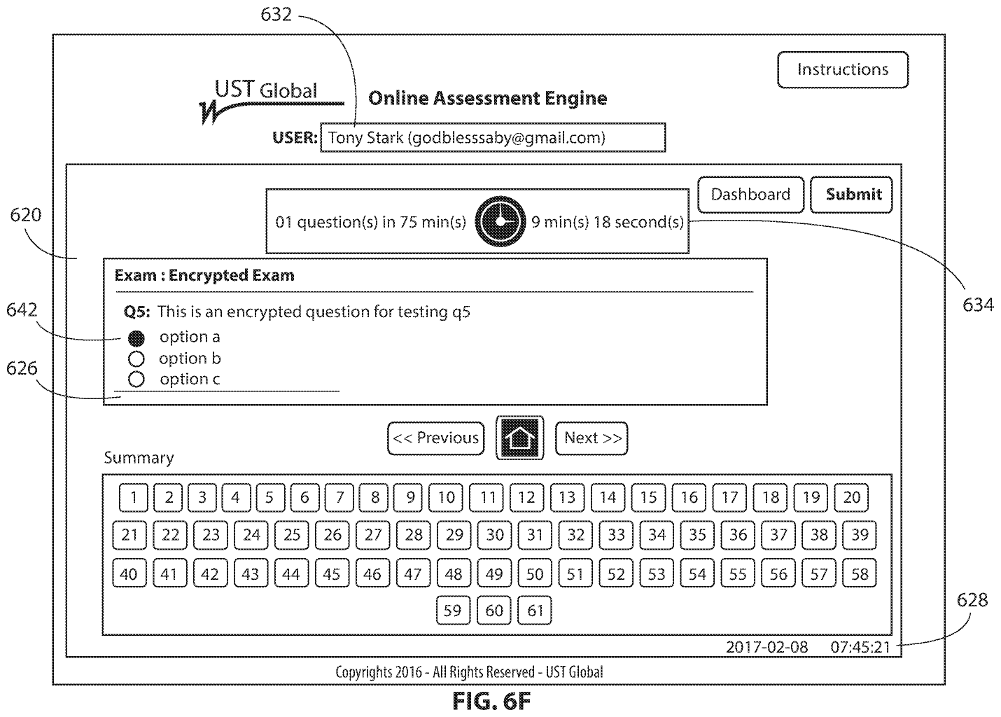

If the credentials are validated (406), the user details are fetched from an associated database (410). The target application then loads an appropriate landing page (412). As will be explained in reference to FIGS. 6-10 below, this process may be audited by the system 100 in FIG. 1.

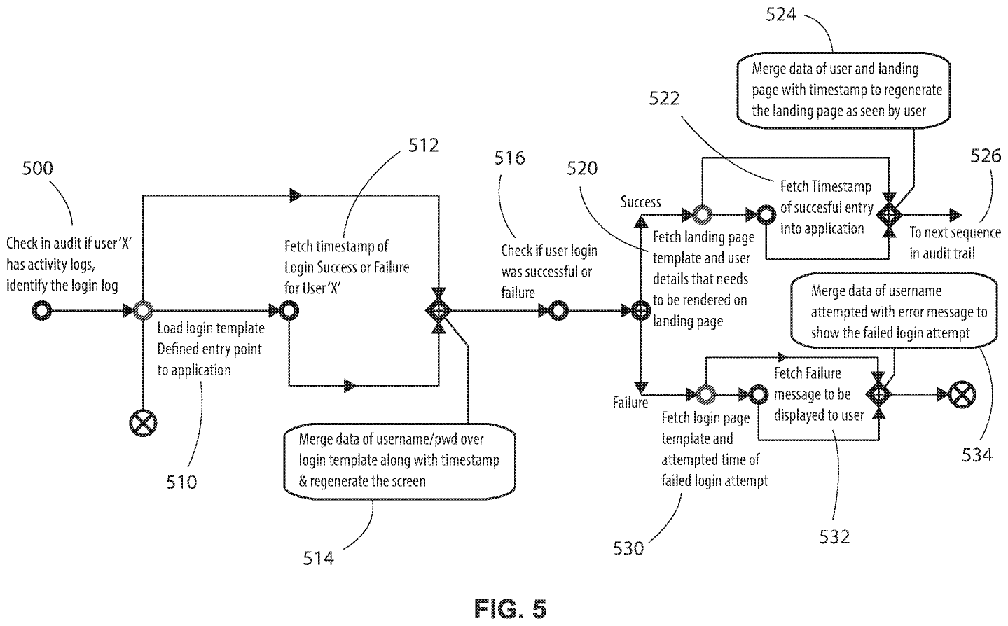

FIG. 5 is the flow diagram of the process that is used by the system 100 to combine audit data and templates to create the appropriate visual audit log for the example log in process of the target application. The process first checks the audit to determine if the user of the target application 110 has any activity logs and identifies the appropriate login log (500). The process loads the login template, which is the defined entry point to the target application 110 (510). The process then fetches the timestamp of either login success or failure of the user (512). The process merges the data (in this example, user name and password) and the timestamp with the login template to generate the screen image (514). The process then checks if the user login was successful or failed (516).

If the user login was successful, the process fetches the landing page template and user details that are required to be rendered on the template (520). The process then fetches the timestamp of either successful entry to the target application 110 (522). The process then merges the user data and timestamp with the landing page template to regenerate the landing page as seen by the user (524). The process then proceeds to the next sequence in the audit trail (526).

If the user login fails (516), the process fetches the login page template and attempted time of the failed login attempt (530). The process then fetches a failure message displayed to the user (532). The process then merges the user data and failure message with the login page template to regenerate the login page with failure message as seen by the user (534).

The system 100 thus is a computing platform that converts user audit data from a target software application such as the target application 110 and displays that data as a sequential visual playback of a user's activities within the target application 110 as per the example process shown in FIGS. 4-5.

By analyzing user behavior data from timestamped audit records of the operation of the audited target application, and matching user actions/entries to static pages/screens captured from the audited target application a true sequential emulation of the user's actions in operating the target application is created. The audit emulation is displayed in a video playback style that allows for easy review. This improves on known systems that display the audit trail as text only. A visual depiction of the exact sequential actions of the user allows more detailed examination of a user's interactions with the target application 110 such as determining the data that was entered and the operation of the application. Thus, visual representation of user actions in relation to a target application benefits system administrators, who may desire to evaluate user proficiency on a particular application. Moreover, the visual-representation renders a format that is readily understandable and accordingly helps the end-users to derive meaningful and accurate auditing of information entered through the target application.

Since an actual real-time video (i.e. a captured through a camera) is not generated, and rather pre-defined templates and overlays are used, the video playback file size is significantly smaller than standard streaming video files of screen activities. The small file size encourages at least allows easy retention and storage of audit data for the playback operation. As used herein, the term “video file” does not include second-by-second screen capture of all the content displayed on the electronic display, as a conventional video, e.g., recording at 30 frames per second, would produce. Rather, the video file according to the concepts disclosed herein is significantly smaller compared to a conventional frame-by-frame video, yet without any loss of information. All of the actions (e.g., user inputs) and content (e.g., text and graphics) during the user's interaction with the target application 110 are captured and capable of being played back at a later time in the precise sequence and time as the original interactions, just as if the original interactions were being manually carried out by the user, without any loss of information. In this case, the present invention produces a lossless audit of a user's interaction with a software application that is highly compressed into a small file size, a feat that is contradictory.

FIGS. 6A-6F is a series of screen shots showing the video playback generated by the system 100 in FIG. 1 for an example interaction with the target audited application 110. The playback includes different templates and actions that are derived from the data shown in the table 200 in FIG. 2 and the general process of the target application shown in FIG. 4. FIG. 6A shows a screen template 600 of a log in screen for a target audited application.

FIG. 6B shows the template 600 with an insertion of object data from a table such as the table in FIG. 2 to show the interaction of a user with the target audited application. In this example, a box 610 shows the insertion of an ID 612 and a password 614 in certain fields. The table 200 in FIG. 2 includes an action type of DOWNLOAD NEW EXAM and an action subtype LOGIN SUCCESS with a valid user ID of “tony” in the first row that is used to generate the object data of the ID 612. A timestamp 618 corresponding to the timestamp data in the column 240 of the table 200 in FIG. 2 is also shown.

FIG. 6C shows a second template 620 of the landing page of the target audited application after the log in information was entered by the user and successful validation has occurred. FIG. 6D shows the template 620 in FIG. 6C with a user field 622, a question time field 624, and an exam field 626 that highlight the areas in the template 620 where dynamic data is inserted. FIG. 6D also shows additional dynamic text inserted in the fields 622, 624, and 626 to reflect the actions of the user in operating the target audited application 110. In this example, user data 632 has been added to a user field 622, question time data 634 has been added to a question time field 626, and the exam type data 636 to an exam field 626. In this example, the second row of the table 200 includes a GET QUESTIONS PER PAGE action and a GET QUESTION PER PAGE for the specific user action subtype. The total time for exam in the action value is referenced to generate the question time data 624. A timestamp 628 corresponding to the timestamp data in the corresponding entry in the second row of the table 200 in FIG. 2 is also shown.

FIG. 6E shows the template 620 modified with a question text 640 in the exam field 626. The timestamp 628, user data 632, and question time data 634 remain in the template 620. The timestamp 628 has been updated to the time the question text 640 is displayed. Thus, the template 620 has been combined with data to show the screen presented to the user of the target audited application 110.

FIG. 6F shows the template 620 modified with the selection of an answer by the user of the target audited application 110, e.g. the online examination based application linked with the table in FIG. 2. In this example, the user has entered an answer to the question displayed by the question data 640 in FIG. 6E. Thus, a new answer text 642 is displayed in the exam field 626. The timestamp 628, user data 632, and question time data 634 remain in the template 620. The timestamp 628 has been updated to the time the answer text 642 is displayed. Thus, the template 620 has been combined with data to show the screen presented to the user of the target audited application 110 after answering one of the exam questions.

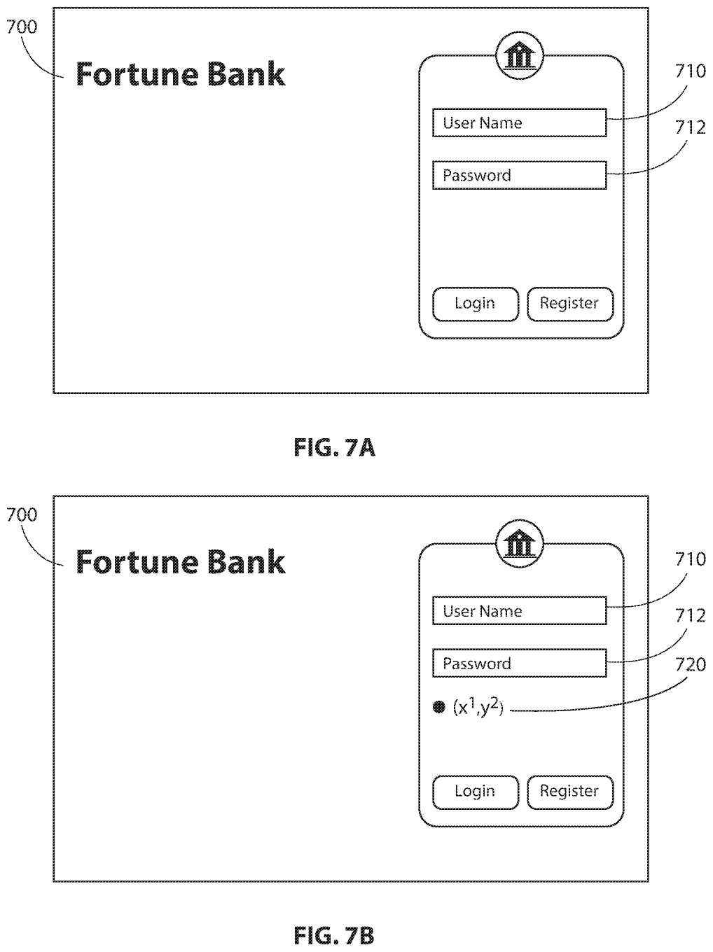

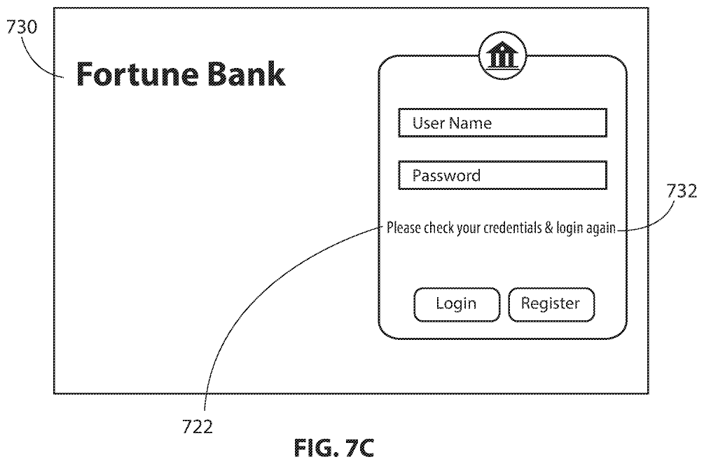

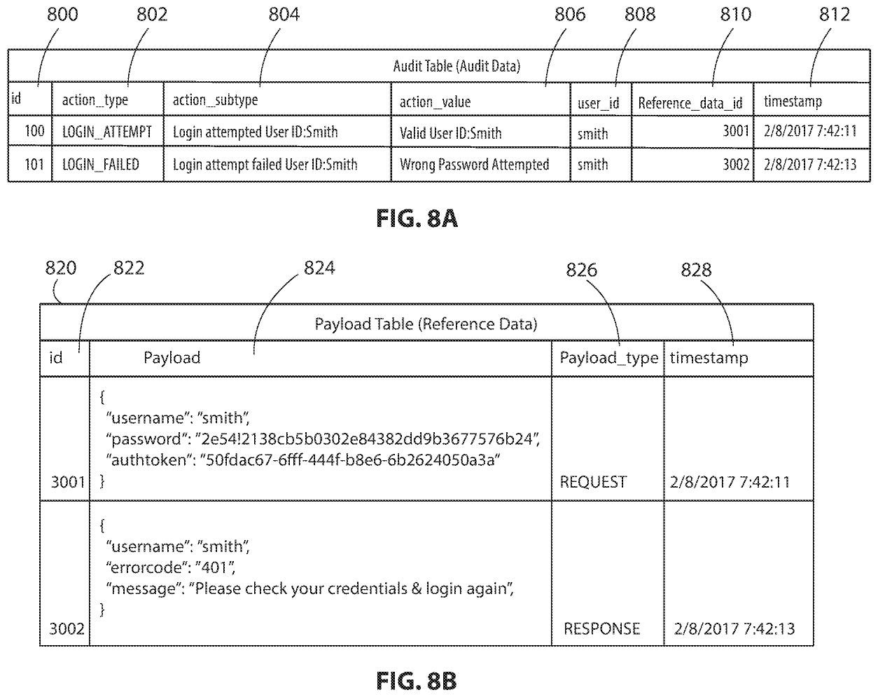

Another example is a sequence shown in screen images of FIGS. 7A-7C and the corresponding data in audit tables in FIGS. 8A-8B. These screen images show how audit visualization performed by the system 100 in FIG. 1 may be used to emulate the login function for an internet banking website application. FIG. 7A shows a template 700 for a login screen. In this example, the template 700 is the initiation point for all simulation and video generation. The template 700 includes a user name field 710 and a password field 712. Similar to the above examples, data text from the audit log files may be used to populate the fields 710 and 712. FIG. 7B shows the template 700 that includes coordinates 722 for inserted data. The indicative coordinates 722 are where the message would be displayed if the login attempt is a failure as per the audit data from the corresponding audit table.

FIG. 7C shows the combined image 730 that is the result of combining the template 700 in FIG. 7B with data from an audit table and a payload table that is used to create a message 732 inserted in the field 722. The corresponding entry is shown in an audit table 800 in FIG. 8A. The audit table 800 is an example of the audit data 122 in FIG. 1. As shown in FIG. 8A, the audit table 800 includes an ID column 802, an action subtype column 804, an action value column 806, a user ID column 808, a reference data ID column 810 and a timestamp column 812. The audit table 800 shows how the application audit captures the audit data in order to enable recreation of a login event.

In this example, the first set of data corresponds with ID “100” and is the LOGIN_ATTEMPT field action type. The action subtype is the login attempted by the Smith user ID. Thus, based on a response for LOGIN_ATTEMPT http request, the audit data table ID “101” in the ID column 802 reveals that the login attempt was a failure and hence a LOGIN_FAILED action_type was logged in the audit table 800. The detailed information of specific payload transmitted to user is available in payload table (reference data) and the exact mapping to the relevant payload is available in audit table's reference_data_id.

FIG. 8B shows a payload table 820 corresponding to the entries in the reference data ID Column 810 in the audit table 800 in FIG. 8A. The payload table 820 is an example of the reference data 124 in FIG. 1. The payload table 820 includes an ID column 822 that corresponds with the reference data ID column 810 in FIG. 8A. The payload table 820 includes a payload column 824, a payload type column 826 and a timestamp column 828. The entries in the timestamp column 828 corresponds with the entries in the timestamp column 812 in the audit table 800 in FIG. 8A. The above reference data from the payload table 820 gives details on what data was shared at what time. In this example, in the field corresponding to the “3001” ID, the payload field includes the data obtained from the user of the audit target application for the user name, password, an authtoken. The message displayed in the combined image 730 is in the payload field corresponding to the “3002” ID.

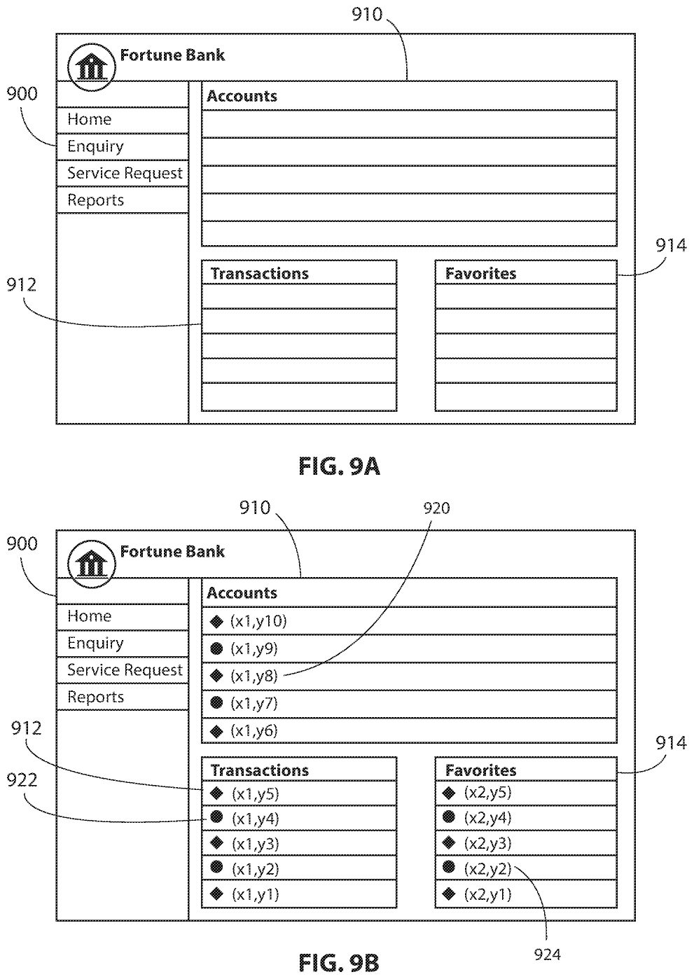

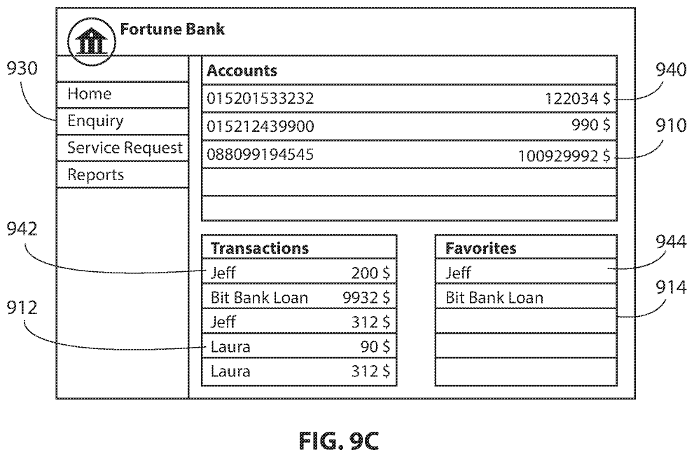

FIG. 9A is another example of a landing page template 900. The example landing page template 900 is a home page of the target application that includes the login template shown in FIGS. 7A-7C and the tables of data in FIGS. 8A-8B. The example landing page template 900 is the logical landing page for a successful login attempt, the information on successful login is available in the entry of data in the image shown in FIG. 7B. The landing page template 900 includes an accounts field 910, a transactions field 912, and a favorites field 914.

FIG. 9B is an image of the landing page template 900 in FIG. 9A that includes three groups of indicative coordinates 920, 922, and 924. The indicative coordinates 920, 922, and 924 indicate where data is inserted in the respective fields 910, 912, and 914 to produce the image of the landing page for the playback.

FIG. 9C is an image of an assembled page 930 that incorporates the template 910 and the data from the audit logs. The page 930 is loaded and renders the information from a successful login response. Data has been filled in at the coordinates 920, 922, and 924 in FIG. 9B. Thus, the assembled page 930 includes account numbers and account balances data 940 in the accounts field 910. The assembled page 930 includes transactions data 942 in the transactions field 912 and favorites data 944 in the favorites field 914.

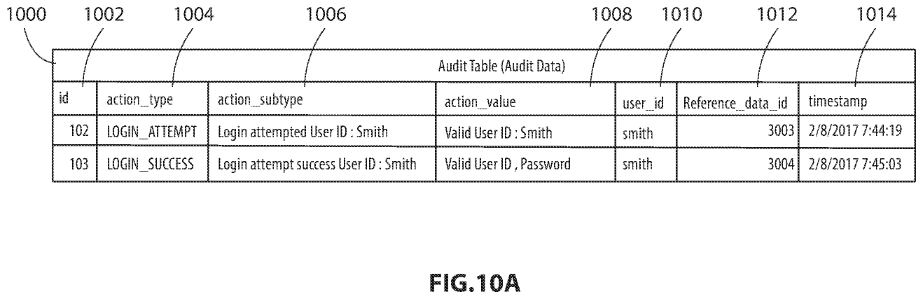

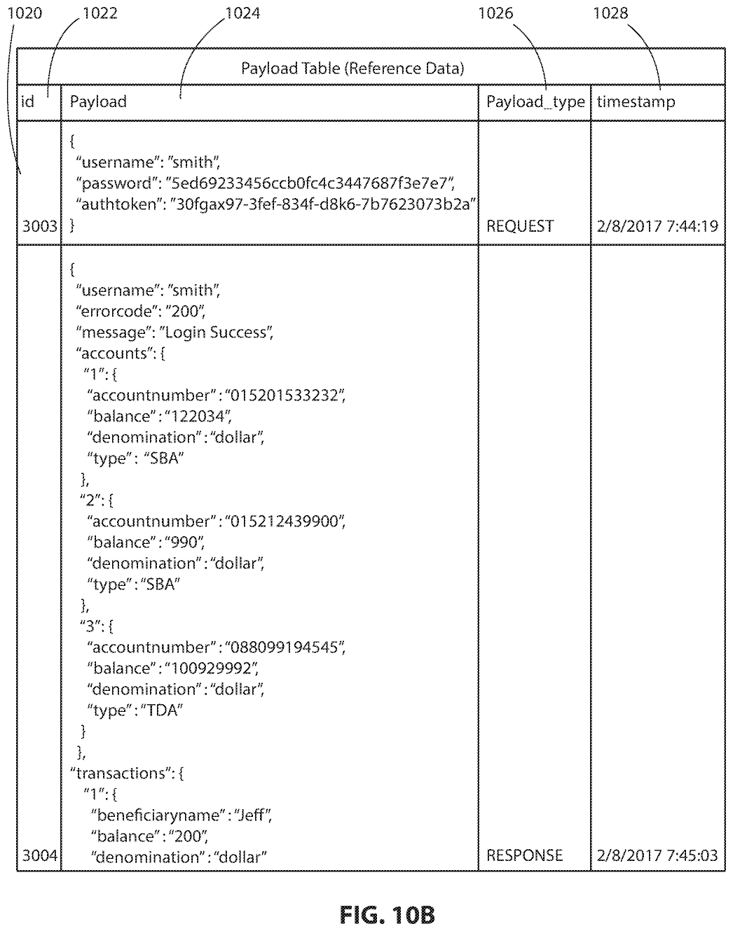

FIG. 10A shows an audit table 1000 that includes an ID column 1002, an action type column 1004, an action subtype column 1006, an action value column 1008, a user ID column 1010, a reference data ID column 1012 and a timestamp column 1014. The audit table 1000 shows how the application audit captures the audit data in the example online banking web page application. The first row of the audit table 1000 includes the LOGIN ATTEMPT action type and the LOGIN ATTEMPTED USER ID subaction. The second row of the audit table 1000 allows the loading the of the landing page shown in FIG. 9C based on successful log in.

FIG. 10B shows a payload table 1020 that supplies data in the coordinates 1022, 1024, and 1026 in the template 900 in FIG. 9B. The payload table 1020 of FIG. 10B corresponds to the entries in the reference data ID Column 1012 in the audit table 1000 of FIG. 10A. More specifically, the payload table 1020 includes a reference data ID column 1022 that corresponds with the reference data ID column 1012 in FIG. 10A. The payload table 1020 includes a payload column 1024, a payload type column 1026 and a timestamp column 1028. The entries in the timestamp column 1028 corresponds with the entries in the timestamp column 1013 in the audit table 1000 in FIG. 10A. The above reference data from the payload table 1020 gives details on what data was shared at what time. In this example, in the field in FIG. 10B corresponding to the “3003” reference data ID, the payload field includes the data obtained from the user of the audit target application for the user name, password, an authtoken for successful login as executed in FIG. 10A. In other words, upon successful authentication, the fields 3003 and 3004 form a part of the reference data ID Column 1012 of FIG. 10A accessing the content of table 1020 in FIG. 2B.

The access of content from the table 1020, upon successful authentication, in turn leads to population of fields in the combined image 930. More specifically, the message displayed in the combined image 930, representing the landing page, is in the payload field corresponding to the “3004” reference data ID. Thus, the payload column entry corresponding to the reference data ID for “3004” includes values for the account number, transactions and favorites. This data is populated in the respective fields 910, 912, and 914 in the assembled page 930 in FIG. 9C.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

The computing device as mentioned in the application can include a set of instructions that can be executed to cause the computer system to perform any one or more of the methods disclosed. The computer system may operate as a standalone-device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system can also be implemented as or incorporated across various devices, such as a personal computer (PC), a tablet PC, a personal digital assistant (PDA), a mobile device, a palmtop computer, a laptop computer, a desktop computer, a communications device, a web appliance, a network router, switch or bridge, or any other machine capable of executing a set of instructions (sequential or otherwise) that specify actions to be taken by that machine. Further, while a single computer system is illustrated, the term “system” shall also be taken to include any collection of systems or sub-systems that individually or jointly execute a set, or multiple sets, of instructions to perform one or more computer functions.

The network as referred in the application may include wired networks, wireless networks, Ethernet AVB networks, or combinations thereof. The wireless network may be a cellular telephone network, an 802.11, 802.16, 802.20, 802.1Q or WiMax network. Further, the network may be a public network, such as the Internet, a private network, such as an intranet, or combinations thereof, and may utilize a variety of networking protocols now available or later developed including, but not limited to TCP/IP based networking protocols. The system is not limited to operation with any particular standards and protocols. For example, standards for Internet and other packet switched network transmission (e.g., TCP/IP, UDP/IP, HTML, HTTP) may be used.

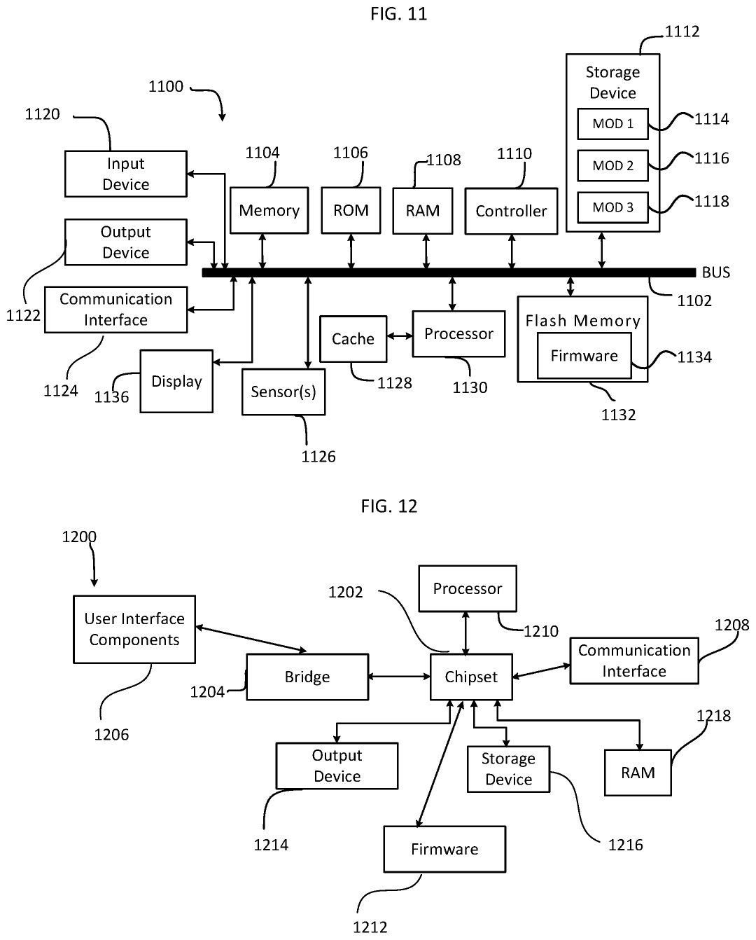

FIG. 11 illustrates an example computing system 1100, in which the components of the computing system are in electrical communication with each other using a bus 1102. The system 1100 includes a processing unit (CPU or processor) 1130, and a system bus 1102 that couples various system components, including the system memory 1104 (e.g., read only memory (ROM) 1106 and random access memory (RAM) 1108), to the processor 1130. The system 1100 can include a cache of high-speed memory connected directly with, in close proximity to, or integrated as part of the processor 1130. The system 1100 can copy data from the memory 1104 and/or the storage device 1112 to the cache 1128 for quick access by the processor 1130. In this way, the cache can provide a performance boost for processor 1130 while waiting for data. These and other modules can control or be configured to control the processor 1130 to perform various actions. Other system memory 1104 may be available for use as well. The memory 1104 can include multiple different types of memory with different performance characteristics. The processor 1130 can include any general purpose processor and a hardware module or software module, such as module 1 1114, module 2 1116, and module 3 1118 embedded in storage device 1112. The hardware module or software module is configured to control the processor 1130, as well as a special-purpose processor where software instructions are incorporated into the actual processor design. The processor 1130 may essentially be a completely self-contained computing system, containing multiple cores or processors, a bus, memory controller, cache, etc. A multi-core processor may be symmetric or asymmetric.

To enable user interaction with the computing device 1100, an input device 1120 is provided as an input mechanism. The input device 1120 can comprise a microphone for speech, a touch-sensitive screen for gesture or graphical input, keyboard, mouse, motion input, and so forth. In some instances, multimodal systems can enable a user to provide multiple types of input to communicate with the system 1100. In this example, an output device 1122 is also provided. The communications interface 1124 can govern and manage the user input and system output.

Storage device 1112 can be a non-volatile memory to store data that are accessible by a computer. The storage device 1112 can be magnetic cassettes, flash memory cards, solid state memory devices, digital versatile disks, cartridges, random access memories (RAMs) 1208, read only memory (ROM) 1106, and hybrids thereof.

The controller 1110 can be a specialized microcontroller or processor on the system 1100, such as a BMC (baseboard management controller). In some cases, the controller 1110 can be part of an Intelligent Platform Management Interface (IPMI). Moreover, in some cases, the controller 1110 can be embedded on a motherboard or main circuit board of the system 1100. The controller 1110 can manage the interface between system management software and platform hardware. The controller 1110 can also communicate with various system devices and components (internal and/or external), such as controllers or peripheral components, as further described below.

The controller 1110 can generate specific responses to notifications, alerts, and/or events, and communicate with remote devices or components (e.g., electronic mail message, network message, etc.) to generate an instruction or command for automatic hardware recovery procedures, etc. An administrator can also remotely communicate with the controller 610 to initiate or conduct specific hardware recovery procedures or operations, as further described below.

The controller 1110 can also include a system event log controller and/or storage for managing and maintaining events, alerts, and notifications received by the controller 1110. For example, the controller 1110 or a system event log controller can receive alerts or notifications from one or more devices and components, and maintain the alerts or notifications in a system event log storage component.

Flash memory 1132 can be an electronic non-volatile computer storage medium or chip that can be used by the system 1100 for storage and/or data transfer. The flash memory 1132 can be electrically erased and/or reprogrammed. Flash memory 1132 can include EPROM (erasable programmable read-only memory), EEPROM (electrically erasable programmable read-only memory), ROM, NVRAM, or CMOS (complementary metal-oxide semiconductor), for example. The flash memory 1132 can store the firmware 1134 executed by the system 1100 when the system 1100 is first powered on, along with a set of configurations specified for the firmware 1134. The flash memory 1132 can also store configurations used by the firmware 1134.

The firmware 1134 can include a Basic Input/Output System or equivalents, such as an EFI (Extensible Firmware Interface) or UEFI (Unified Extensible Firmware Interface). The firmware 1134 can be loaded and executed as a sequence program each time the system 1100 is started. The firmware 1134 can recognize, initialize, and test hardware present in the system 1200 based on the set of configurations. The firmware 1134 can perform a self-test, such as a POST (Power-on-Self-Test), on the system 1100. This self-test can test the functionality of various hardware components such as hard disk drives, optical reading devices, cooling devices, memory modules, expansion cards, and the like. The firmware 1134 can address and allocate an area in the memory 1104, ROM 1106, RAM 1108, and/or storage device 1112, to store an operating system (OS). The firmware 1134 can load a boot loader and/or OS, and give control of the system 1100 to the OS.

The firmware 1134 of the system 1100 can include a firmware configuration that defines how the firmware 1134 controls various hardware components in the system 1200. The firmware configuration can determine the order in which the various hardware components in the system 1100 are started. The firmware 1134 can provide an interface, such as an UEFI, that allows a variety of different parameters to be set, which can be different from parameters in a firmware default configuration. For example, a user (e.g., an administrator) can use the firmware 1134 to specify clock and bus speeds; define what peripherals are attached to the system 1100; set monitoring of health (e.g., fan speeds and CPU temperature limits); and/or provide a variety of other parameters that affect overall performance and power usage of the system 1100. While firmware 1134 is illustrated as being stored in the flash memory 1132, one of ordinary skill in the art will readily recognize that the firmware 1234 can be stored in other memory components, such as memory 1104 or ROM 1106.

System 1100 can include one or more sensors 1126. The one or more sensors 1126 can include, for example, one or more temperature sensors, thermal sensors, oxygen sensors, chemical sensors, noise sensors, heat sensors, current sensors, voltage detectors, air flow sensors, flow sensors, infrared thermometers, heat flux sensors, thermometers, pyrometers, etc. The one or more sensors 1126 can communicate with the processor, cache 1128, flash memory 1132, communications interface 1124, memory 1104, ROM 1106, RAM 1108, controller 1110, and storage device 1112, via the bus 1102, for example. The one or more sensors 1126 can also communicate with other components in the system via one or more different means, such as inter-integrated circuit (I2C), general purpose output (GPO), and the like. Different types of sensors (e.g., sensors 1126) on the system 1100 can also report to the controller 1110 on parameters, such as cooling fan speeds, power status, operating system (OS) status, hardware status, and so forth. A display 1136 may be used by the 1100 to provide graphics related to the applications that are executed by the controller 1110, or the processor 1130.

FIG. 12 illustrates an example computer system 1200 having a chipset architecture that can be used in executing the described method(s) or operations, and generating and displaying a graphical user interface (GUI). Computer system 1200 can include computer hardware, software, and firmware that can be used to implement the disclosed technology. System 1200 can include a processor 1210, representative of a variety of physically and/or logically distinct resources capable of executing software, firmware, and hardware configured to perform identified computations. Processor 1210 can communicate with a chipset 1202 that can control input to and output from processor 1210. In this example, chipset 1202 outputs information to output device 1214, such as a display, and can read and write information to storage device 1216. The storage device 1216 can include magnetic media, and solid state media, for example. Chipset 1202 can also read data from and write data to RAM 1218. A bridge 1204 for interfacing with a variety of user interface components 1206, can be provided for interfacing with chipset 1202. User interface components 1206 can include a keyboard, a microphone, touch detection and processing circuitry, and a pointing device, such as a mouse.

Chipset 1202 can also interface with one or more communication interfaces 1208 that can have different physical interfaces. Such communication interfaces can include interfaces for wired and wireless local area networks, for broadband wireless networks, and for personal area networks. Further, the machine can receive inputs from a user via user interface components 1206, and execute appropriate functions, such as browsing functions by interpreting these inputs using processor 1210.

Moreover, chipset 1202 can also communicate with firmware 1212, which can be executed by the computer system 1200 when powering on. The firmware 1212 can recognize, initialize, and test hardware present in the computer system 1300 based on a set of firmware configurations. The firmware 1212 can perform a self-test, such as a POST, on the system 1200. The self-test can test the functionality of the various hardware components 1202-1218. The firmware 1212 can address and allocate an area in the RAM memory 1218 to store an OS. The firmware 1212 can load a boot loader and/or OS, and give control of the system 1200 to the OS. In some cases, the firmware 1212 can communicate with the hardware components 1202-1210 and 1214-1218. Here, the firmware 1212 can communicate with the hardware components 1202-1210 and 1214-1218 through the chipset 1202, and/or through one or more other components. In some cases, the firmware 1212 can communicate directly with the hardware components 1202-1210 and 1214-1218.

It can be appreciated that example systems 1100 and 1200 can have more than one processor (e.g., 1130, 1210), or be part of a group or cluster of computing devices networked together to provide greater processing capability.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

We claim:

1. A system to generate an audit trail based on operation of a target application, the system comprising:
a computing device operable to execute the target application, the computing device including an input device and a display, wherein the target application generates a plurality of user interfaces on the display and audit data in response to user inputs received from the input device;
a memory coupled to the computing device to store the audit data generated by the target application; and
an auditing device coupled to the memory and the computing device, the auditing device operable to generate a video file of the operation of the target application based on one of a plurality of templates, each of the templates corresponding to one of the user interfaces, and the audit data generated from a user input received from the input device, the user input associated with one of the user interfaces.

2. The system of claim 1, further comprising a display coupled to the auditing device for playing the generated video file of the operation of the target application.

3. The system of claim 1, further comprising a database with reference data generated by the computing device in the execution of the target application, wherein the reference data is incorporated in the generated video file.

4. The system of claim 1, further comprising a network coupled to the computing device, memory and auditing device.

5. The system of claim 1, wherein the audit data is extracted from the target application and converted for storage in the memory by one of JDBC, ODBC, Web services or API.

6. The system of claim 1, wherein the audit data includes a timestamp for individual actions.

7. The system of claim 1, wherein input device is a mouse, and wherein the video file includes inputs that track mouse movement on the one of the user interfaces.

8. The system of claim 1, wherein the video file includes frames that each include one of the templates showing an interface of the target application and a dynamic element derived from the audit data.

9. The system of claim 1, further comprising an audit visualization framework that dissects each of the user interfaces into static and dynamic elements, wherein the static elements are those that remain the same irrespective of a user of the target application, a time of login, or a state of the user or of the target application information, and wherein the dynamic elements are variable elements in the user interface, the audit visualization framework being configured to recreate the dynamic elements and overlay content of the dynamic elements to recreate a state or appearance of any of the user interfaces and interaction by the user with any of the user interfaces at any given instant of time in the past.

10. A method of providing a visual audit trail of operating a target application, the method comprising:
executing the target application from a computing device, the target application generating audit data associated with the actions of a user operating the target application;
storing the audit data in a database on a storage device;
accessing a template associated with a user interface generated by the target application; and
generating an audit video file from the template and the audit data, the audit video indicative of the actions of the user operating the target application.

11. The method of claim 10, further comprising:
dissecting the user interface into static and dynamic elements, wherein the static elements are those that remain the same irrespective of a user of the target application, a time of login, or a state of the user or of the target application information, and wherein the dynamic elements are variable elements in the user interface; and
recreating the dynamic elements and overlay content of the dynamic elements to recreate a state or appearance of the user interface and interaction by the user with the user interface at any given instant of time in the past.

12. The method of claim 10, further comprising playing the generated video file of the operation of the target application on a display.

13. The method of claim 10, wherein the audit data is extracted from the target application and converted for storage by one of JDBC, ODBC, Web services or API.

14. The method of claim 10, wherein the audit data includes a timestamp for individual actions.

15. The method of claim 10, wherein the actions of the user include operation of an input device.

16. The method of claim 15, wherein the input device is a mouse, and wherein the video file includes inputs that track mouse movement on the one of the user interfaces.

17. The method of claim 10, wherein the audit video file includes frames that each include one of the templates showing an interface of the target and a dynamic element derived from the audit data.
